(19) United States
(12) Patent Application Publication
(10) Pub. No.: US 2018/0040084 A1
(43) Pub. Date: Feb. 8, 2018

(54) METHOD AND AN APPARATUS FOR EFFECTING A TRANSACTION

(71) Applicant: MasterCard International Incorporated, Purchase, NY (US)

(72) Inventor: Ravi Pareek, Pune (IN)

(21) Appl. No.: 15/653,928

(22) Filed: Jul. 19, 2017

(30) Foreign Application Priority Data
Aug. 2, 2016 (SG) 10201606364P

(51) Int. Cl. G06Q 50/18; G06Q 30/02; G06Q 30/06

(52) U.S. Cl. CPC G06Q 50/188; G06Q 30/0601; G06Q 30/0222; G06Q 30/06; G06Q 30/0637; G06Q 30/0611

(57) ABSTRACT

A computer-implement method, at a server, for effecting a transaction is disclosed, the method comprising the steps of receiving, from a payee device, a payee payment threshold amount identifying a minimum amount that a payee is willing to accept for a predetermined number of goods for the transaction; receiving, from a payer device, a payer payment threshold amount identifying a maximum amount that a payer is willing to pay for the transaction; determining if the payer payment threshold amount is equal to or more than the payee payment threshold amount; and effecting the transaction if it is determined that the payer payment threshold amount is equal to or more than the payee payment threshold amount.

### CROSS-REFERENCE TO RELATED APPLICATION

This application is a U.S. National Stage filing under 35 U.S.C. § 119, based on and claiming benefit of and priority to SG Patent Application No. 10201606364P filed Aug. 2, 2016.

### TECHNICAL FIELD

The present disclosure relates to a method and an apparatus for effecting a transaction.

### BACKGROUND

Bulk purchasing, where an unusually large quantity of goods and services are purchased at an unusually low price, is ubiquitous in contemporary economies. For example, consumers are often allured to big-box stores or mega stores, where they can capture part of the benefits of economy of scale by paying a lower price per unit in exchange for purchasing much larger quantities. Even in common places like supermarkets, discounts are also often given to customers when they buy at least two or more items of the same kind.

A variant of bulk purchasing which is gaining popularity in recent years is group buying, where a large number of people is rounded to buy the same product to enjoy a group discount. This gives rise to recently popular platforms such as Groupon, Deals.com, Taobao.com etc., where potential consumers can enjoy quantity discounts on selected products advertised by merchants on these platforms. However, the customers are often ignorant to the inner workings between these platforms and the merchants as these platforms act as an interface between the customers and the merchants. As such, the customers are unable to interact with their desired merchants first-hand to customize their purchases depending on their needs.

In view of the above, it would be desirable to provide a method and an apparatus allowing the customers and merchants to interact first-hand with selected merchants to customize their purchases, which overcomes one or more of the above disadvantages, or which at least provides a useful alternative.

Furthermore, other desirable features and characteristics will become apparent from the subsequent detailed description and the appended claims, taken in conjunction with the accompanying drawings and this background of the disclosure.

### SUMMARY

According to a first aspect of the invention, a computer-implemented method, at a server, for effecting a transaction is described, the method comprising the steps of receiving, from a payee device, a payee payment threshold amount identifying a minimum amount that a payee is willing to accept for a predetermined number of goods for the transaction; receiving, from a payer device, a payer payment threshold amount identifying a maximum amount that a payer is willing to pay for the transaction; determining if the payer payment threshold amount is equal to or more than the payee payment threshold amount; and effecting the transaction if it is determined that the payer payment threshold amount is equal to or more than the payee payment threshold amount.

In an embodiment, the method further comprises the steps of determining if a payer account associated with the payer is authorised to be used for the transaction based on the payer payment threshold amount, wherein it is determined that the payer account is authorised to be used for the transaction if an amount in the payer account exceeds the payer payment threshold amount.

In an embodiment, the method further comprises the steps of generating a transaction token for the transaction when it is determined that the payer payment threshold amount is equal to or more than the payee payment threshold amount, the transaction token including at least a transaction amount, and a transaction token validity time period during which the payer can proceed to initiate the transaction; and sending the transaction token to the payer device.

In an embodiment, the method further comprises the steps of receiving, from the payer device, a transaction request during the transaction token validity time period to initiate the transaction, the transaction request including payer data; and forwarding the transaction request to the payee device.

In an embodiment, the method further comprises the steps of receiving from the payee device, a transaction response approving the transaction request; and initiating the transaction in response to receiving the transaction response.

In an embodiment, the method further comprises the steps of receiving, from at least one further payer device, at least one further payer payment threshold amount identifying at least one further maximum amount that at least one further payer is willing to pay for the transaction; determining if the at least one further payer payment threshold amount is equal to or more than the payee payment threshold amount, wherein the transaction is effected if it is determined that the at least one further payer payment threshold amount is equal to or more than the payee payment threshold amount.

In an embodiment, the method further comprises the steps of receiving, from the payee device, at least one further payee payment threshold amount identifying at least one further minimum amount that the payee is willing to accept for at least one further predetermined number of goods for the transaction; determining if at least one of (i) the payer payment threshold amount and (ii) the at least one further payer payment threshold amount is equal to or more than at least one of (i) the payee payment threshold amount and (ii) the at least one further payee payment threshold amount; wherein the transaction is effected if it is determined that at least one of (i) the payer payment threshold amount and (ii) the at least one further payer payment threshold amount is equal to or more than at least one of (i) the payee payment threshold amount and (ii) the at least one further payee payment.

In an embodiment, the method further comprises the steps of receiving, from the payer device, an invitation request inviting the at least one further payer device to participate in the transaction; sending the invitation request to the at least one further payer device; wherein the at least one further payer payment threshold amount is received from the at least one further payer device in response to the invitation request to participate in the transaction.

In an embodiment, the method further comprises the steps of generating an invitation token in response to receiving the invitation request, the invitation token including at least an invitation token validity time period during which the at least one further payer can proceed to participate in the transaction; and sending the invitation token to the at least one further payer device.

In an embodiment, the invitation token further comprises the payee payment threshold amount.

In an embodiment, the transaction amount is equal to the payee payment threshold amount.

In an embodiment, the transaction amount is blocked in the payer account when the transaction is initiated.

In an embodiment, the step of generating a transaction token for the transaction when it is determined that the payer payment threshold amount is equal to or more than the payee payment threshold amount further comprises generating the transaction token by a further server, the further server being operationally connected to the server.

According to a second aspect of the invention, an apparatus for effecting a transaction is described, the apparatus comprising at least one processor and at least one memory including computer program code, the at least one memory and the computer program code are configured to, with at least one processor, cause the apparatus at least to: receive, from a payee device, a payee payment threshold amount identifying a minimum amount that a payee is willing to accept for a predetermined number of goods for the transaction; receive, from a payer device, a payer payment threshold amount identifying a maximum amount that a payer is willing to pay for the transaction; determine if the payer payment threshold amount is equal to or more than the payee payment threshold amount; and effect the transaction if it is determined that the payer payment threshold amount is equal to or more than the payee payment threshold amount.

In an embodiment, the apparatus comprising the at least one memory and the computer program code is further configured with the at least one processor to determine if a payer account associated with the payer is authorised to be used for the transaction based on the payer payment threshold amount, wherein it is determined that the payer account is authorised to be used for the transaction if an amount in the payer account exceeds the payer payment threshold amount.

In an embodiment, the apparatus comprising the at least one memory and the computer program code is further configured with the at least one processor to generate a transaction token for the transaction when it is determined that the transaction will proceed, the transaction token including at least a transaction amount, and a transaction token validity time period during which the payer can proceed to initiate the transaction; and send the transaction token to the payer device.

In an embodiment, the apparatus comprising the at least one memory and the computer program code is further configured with the at least one processor to receive, from the payer device, a transaction request during the transaction token validity time period to initiate the transaction, the transaction request including payer data; and forward the transaction request to the payee device.

In an embodiment, the apparatus comprising the at least one memory and the computer program code is further configured with the at least one processor to receive from the payee device, a transaction response approving the transaction request; and initiate the transaction in response to receiving the transaction response.

In an embodiment, the apparatus comprising the at least one memory and the computer program code is further configured with the at least one processor to receive, from at least one further payer device, at least one further payer payment threshold amount identifying at least one further maximum amount that at least one further payer is willing to pay for the transaction; determine if the at least one further payer payment threshold amount is equal to or more than the payee payment threshold amount, wherein the transaction is effected if it is determined that the at least one further payer payment threshold amount is equal to or more than the payee payment threshold amount.

In an embodiment, the apparatus comprising the at least one memory and the computer program code is further configured with the at least one processor to receive, from the payee device, at least one further payee payment threshold amount identifying at least one further minimum amount that the payee is willing to accept for at least one further predetermined number of goods for the transaction; determine if at least one of (i) the payer payment threshold amount and (ii) the at least one further payer payment threshold amount is equal to or more than at least one of (i) the payee payment threshold amount and (ii) the at least one further payee payment threshold amount; wherein the transaction is effected if it is determined that at least one of (i) the payer payment threshold amount and (ii) the at least one further payer payment threshold amount is equal to or more than at least one of (i) the payee payment threshold amount and (ii) the at least one further payee payment.

In an embodiment, the apparatus comprising the at least one memory and the computer program code is further configured with the at least one processor to receive, from the payer device, an invitation request inviting the at least one further payer device to participate in the transaction; send the invitation request to the at least one further payer device; wherein the at least one further payer payment threshold amount is received from the at least one further payer device in response to the invitation request to participate in the transaction.

In an embodiment, the apparatus comprising the at least one memory and the computer program code is further configured with the at least one processor to generate an invitation token in response to receiving the invitation request, the invitation token including at least an invitation token validity time period during which the at least one further payer can proceed to participate in the transaction; and send the invitation token to the at least one further payer device.

In an embodiment, the invitation token further comprises the payee payment threshold amount.

In an embodiment, the transaction amount is equal to the payee payment threshold amount.

In an embodiment, the transaction amount is blocked in the payer account when the transaction is initiated.

In an embodiment, the apparatus comprising the at least one memory and the computer program code is further configured with the at least one processor to generate a transaction token for the transaction when the transaction is effected is further configured to generate the transaction token by a further server, the further server is operationally connected to the server.

In a third aspect of the invention, a computer-readable storage medium is described, the computer-readable storage medium having stored thereon computer program code which when executed by a computer causes the computer to execute a method in accordance with any of the method described herein.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments, by way of example only, and to explain various principles and advantages in accordance with a present embodiment.

FIG. 1 depicts a block diagram of a system for effecting a transaction in accordance with a first embodiment.

FIG. 2, comprising FIG. 2A and FIG. 2B, depicts effecting a transaction in accordance with the first embodiment, wherein FIG. 2A depicts the steps of receiving a payee payment threshold amount, receiving a payer payment threshold amount, determining if the payer payment threshold amount is equal to or more than the payee payment threshold amount, and effecting the transaction; and FIG. 2B depicts the steps of generating a transaction token, sending the transaction token to a payer device, receiving a transaction request from the payer device, forwarding the transaction request to the payee device, receiving a transaction response approving the transaction request, and initiating the transaction.

FIG. 3 depicts a block diagram of a system for effecting a transaction in accordance with a second embodiment.

FIG. 4, depicts a flow chart of additional steps in the method for effecting a transaction in accordance with the second embodiment, wherein step 204 of FIG. 2A further comprises receiving an invitation request from the payer device, generating an invitation token, sending the invitation token and an invitation request to one further payer device, and receiving the payer payment threshold amount and a further payer payment threshold amount.

FIG. 5 depicts a schematic diagram of a computer system suitable for use in executing the methods depicted in FIG. 2 and FIG. 4.

FIG. 6 depicts an exemplary computing device to realise a server for the payment network server 106 shown in FIG. 1 and FIG. 3.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “determining”, “forwarding”, “generating”, “initiating”, “receiving”, “retrieving”, “identifying”, “sending”, “updating”, “completing”, “effecting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various embodiments relate to a method and an apparatus for effecting a transaction. In an embodiment, the method for effecting a transaction comprises a payer payment threshold amount identifying a maximum amount a payer is willing to pay for the transaction, a payee payment threshold amount identifying a minimum amount a payee is willing to accept for a predetermined number of goods for the transaction. In another embodiment, the method for effecting a transaction further comprises a transaction token comprising at least a transaction amount and a transaction token validity time period during which the payer can proceed to initiate the transaction; and an invitation token comprising at least an invitation token validity time period during which at least one further payer can proceed to participate in the transaction.

In the following description, a transaction is effected utilizing a payment threshold method. A payment threshold method includes comparing a payer payment threshold amount with a payee payment threshold amount, and determining if the payer payment threshold amount is at least equal to or more than the payee payment threshold amount to effect the transaction. In an embodiment, the payer may be a customer and the payee may be a merchant. In an embodiment, a payee payment threshold amount maybe a predetermined price for a predetermined number of goods as determined by the merchant. In one example, the customer may have access to the payee payment threshold amount for a predetermined number of goods from a platform, where the platform can be an electronic platform advertising the goods of the merchant. In some embodiments, the customer may set the payer payment threshold amount through a payer device using a payer account maintained at an issuer server, in response to the payee payment threshold amount of the merchant. In other embodiments, the payer account may be maintained at a payment network server. In some embodiments, a transaction token is generated by the issuer server when it is determined that the transaction is effected. In other embodiments, the transaction token is generated by the payment network server. In an embodiment, an invitation token is generated by an issuer server when an invitation request is received by the issuer server from the payer device. In another embodiment, the invitation token can be generated at the payment network server when the payment network server receives the invitation request. In an embodiment, the transaction is a payment transaction. In other words, effecting the transaction involves a payment between parties to the transaction.

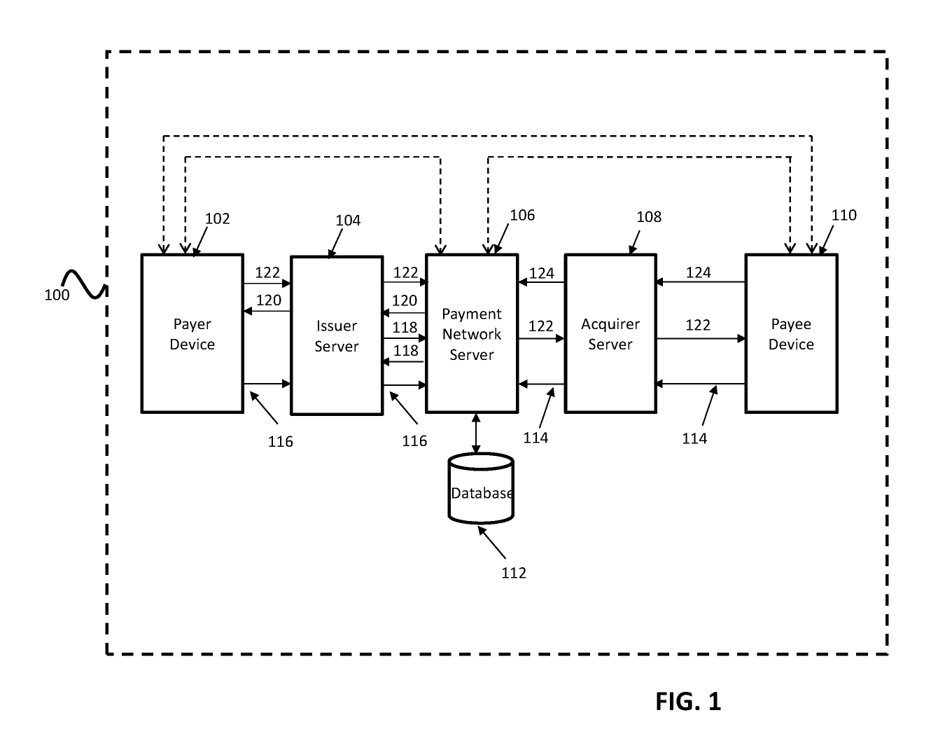

FIG. 1 illustrates a block diagram of a system 100 within which data from the payer and payee can be received and processed.

The system 100 comprises a payer device 102 in communication with an issuer server 104. The payer device 102 may also be in direct communication with a payment network server 106, without having to communicate with the issuer server 104. In specific embodiments, the payer device 102 may also be in direct communication with a payee device 110, without having to communicate with the issuer server 104 or the payment network server 106.

In the system 100, the issuer server 104 is in communication with the payment network server 106. The payment network server 106, in turn, is in communication with an acquirer server 108. The acquirer server 108, in turn, is in communication with the payee device 110. In specific embodiments, the payment network server 106 may also be in direct communication with the payee device 110.

Use of the term ‘server’ herein can mean a single computing device or a plurality of interconnected computing devices which operate together to perform a particular function. That is, the server may be contained within a single hardware unit or be distributed among several or many different hardware units.

The payer device 102 typically is associated with a customer who is a party to a transaction that occurs between the payer device 102 and the payee device 110 through a transaction. The payer device 102 may be a fixed (wired) computing device or a wireless (portable) computing device. In specific implementations, the payer device 102 may be a handheld or portable or mobile device carried or used by the customer, or may refer to other types of electronic devices such as a personal computer, a land-line telephone or an interactive voice response (IVR) system and the like. The mobile device may be a device, such as a mobile phone, a laptop computer, a personal digital computer (PDA), a mobile computer, a portable music player (such as an iPod™ and the like).

The issuer server 104 generally is associated with an issuer and may include one or more computing devices that are used to perform a payment transaction. The issuer may be an entity (e.g. a company or organization, such as a bank, a mobile network operator or a retailer) which issues (e.g. establishes, manages, administers) a transaction credential or an account (e.g. a financial bank account). An account, which may also be termed as a payer account, may be associated with a plurality of payer devices 102.

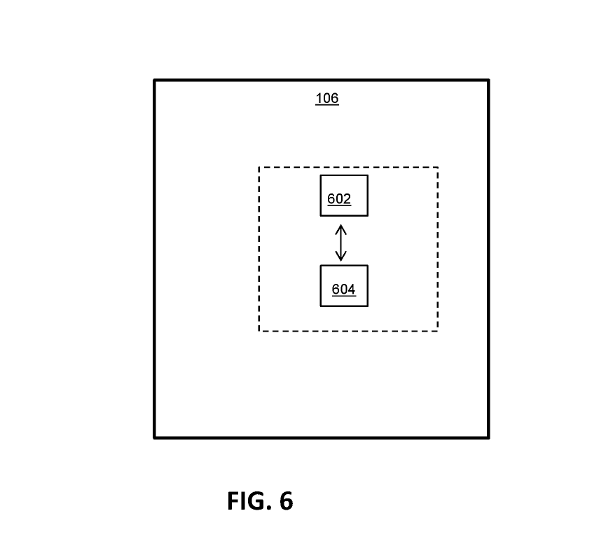

The payment network server 106 typically is associated with a payment network. For example, the payment network server 106 may be part of the Banknet® network operated by MasterCard®. The payment network (e.g. MasterCard®) operates to process transactions, clear and settle funds for payments between two entities (e.g. two banks). The payment network server 106 may include one or more computing devices that are used for processing transactions. An exemplary payment network server 106 is shown in FIG. 6.

The acquirer server 108 generally is associated with an acquirer who may be an entity (e.g. a company or organization) which issues (e.g. establishes, manages, administers) a transaction credential or an account (e.g. a financial bank account) of the payee/merchant. An account of the payee/merchant may also be known as a payee account. Examples of the acquirer include a bank and/or other financial institution. As stated in the above, the acquirer server 108 may include one or more computing devices that are used to establish communication with another server by exchanging messages with and/or passing information to the other server.

The payee device 110 typically is associated with a payee/merchant who is also a party to the transaction that occurs between the payer device 102 and the payee device 110 through the transaction. In an embodiment, the payee device 110 may also be associated with any one party who has an arrangement with the payer to execute a transaction between them. The payee device 110 may be a point-of-sale (POS) terminal, an automatic teller machine (ATM), a personal computer, a computer server (hosting a website, for example), an IVR system, a land-line telephone, or any type of mobile device such as a mobile phone, a personal digital assistant (PDA), a laptop computer, a tablet computer and the like.

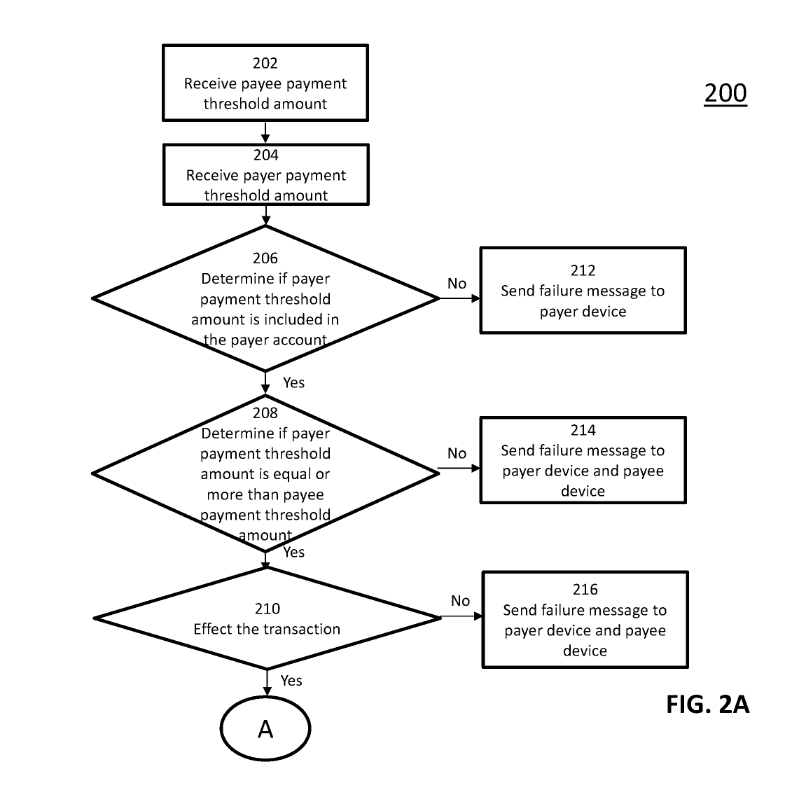

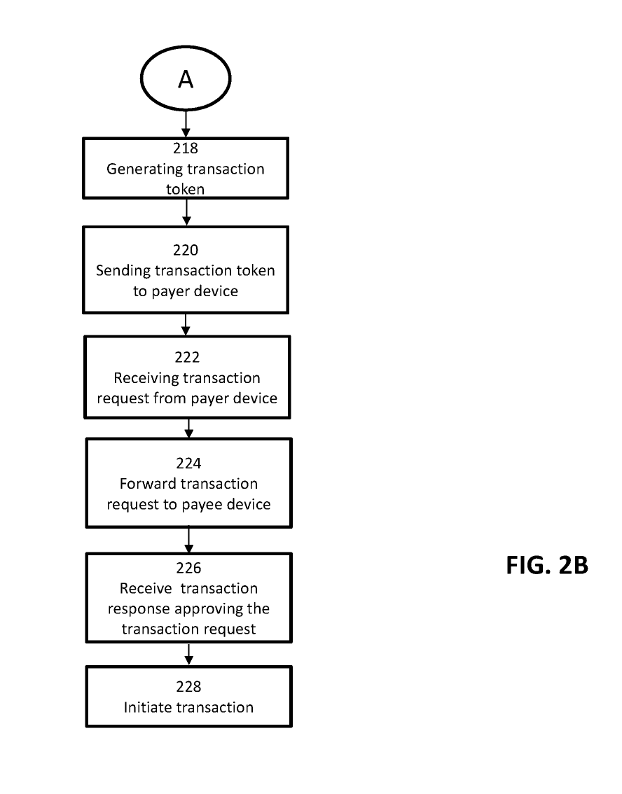

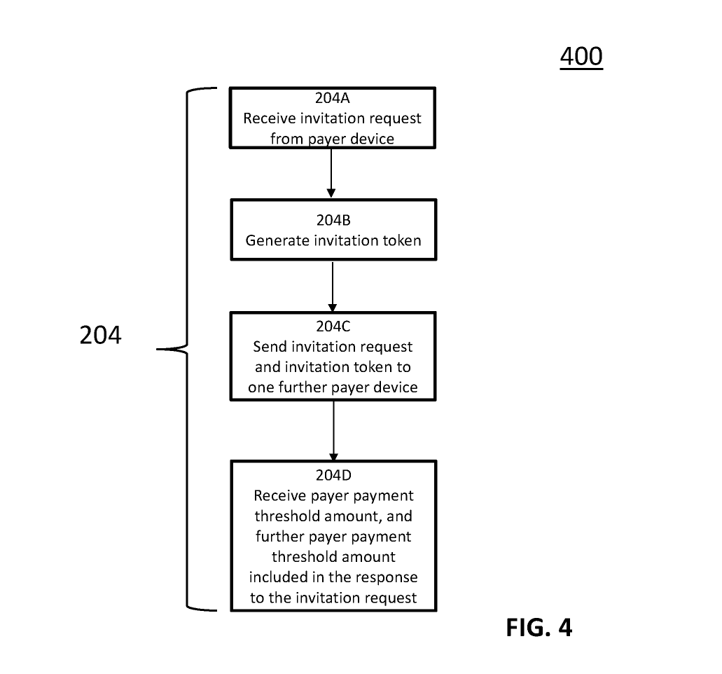

The payment network server 106 may be configured to communicate with, or may include, a database (or a transaction database) 112. The transaction database 112 stores data corresponding to a transaction (or transaction data). Examples of the data include Transaction ID, Payee ID, Payer Name, Payee Name, Payee Country, Payee Address, Payee Postal Code. For example, data (“Payee name” or “Payee ID”) relating to the payee, time and date for which the goods/services relating to the transaction will be delivered are included in the database 112. In some embodiments, the data also include payer data which identify a payer account and payee data which identify a payee account. In some embodiments, the payer account and the payee account are associated with corresponding accounts in the issuer server and the acquirer server respectively. In some embodiments, the data also comprise transaction history of the payer and the payee. In some embodiments, the data also comprise a list of payer payment threshold amounts and a list of payee payment threshold amounts for a list of payers and payees who are registered to use payment threshold for effecting a transaction. In some embodiments, the data also comprise information associated with a transaction token including at least a transaction amount and a transaction token validity time period during which the payer can proceed to initiate the transaction. In an embodiment, the data also comprise information associated with an invitation token including at least an invitation token validity time period during which at least one further payer can proceed to participate in the transaction. Further details on how these data are utilised and managed are described in FIG. 2 and FIG. 4 below.

In a preferred embodiment, the payer device 102 is capable of wireless communication using a suitable protocol with the issuer server 104. In some embodiments, the wireless communication comprises established telecommunication known in the art such as GSM, CDMA, WIFI or the like. In some embodiments, the wireless communication is established through the Internet via a website associated with the issuer server 104. In another embodiment, the payer device 102 is capable of wireless communication using a suitable protocol with the payee device 110. For example, embodiments may be implemented using payer devices 102 that are capable of communicating with WiFi/Bluetooth-enabled payee devices 110. It will be appreciated by a person skilled in the art that depending on the wireless communication protocol used, appropriate handshaking procedures may need to be carried out to establish communication between the payer device 102 and the payee device 110. For example, in the case of Bluetooth communication, discovery and pairing of the payer device 102 and the payee device 110 may be carried out to establish communication.

In an example, in effecting a transaction by using various payment thresholds, a payee payment threshold amount 114 identifying a minimum amount that a payee is willing to accept for a predetermined number of goods for a transaction is first generated at the payee device 110. In some embodiments, there may be at least one further payee payment threshold amount 114 generated at the payee device, where the at least one further payee payment threshold amount identifies at least one further minimum amount that the payee is willing to accept for at least one further predetermined number of goods for the transaction. In an embodiment, the payee payment threshold amounts generated by the payee may be a list of prices, each price being for a predetermined number of goods. For example, the payee may want to price a good in terms of its predetermined number of quantity sold in a single transaction. In some embodiments, a price of a good maybe lower if a bigger quantity of the same type of good is sold in a single transaction. In other words, a price for the same type of good may be lower if the good is sold to a payer in a quantity of 10 as compared to selling to the payer in a quantity of 1. In an embodiment, the payer may have made arrangements/agreements with the payee, resulting in the payee payment threshold amount 114. In some embodiments, the payer and the payee are registered users of (i) accounts issued by a bank or financial institution and maintained at an issuer server 104 and (ii) accounts issued by a bank or financial institution and maintained at an acquirer server 108 respectively. Alternatively, the payer and the payee may be registered users of accounts issued directly with a payment network server 106. The payee payment threshold amount 114 generated by the payee device 110 may then be communicated to the payment network server 106 via the acquirer server 108. In another embodiment, the payee payment threshold amount 114 may be communicated directly to the payment network server 106 without communicating the payee payment threshold amount 114 via the acquirer server 108. In some embodiments, the payee payment threshold amount 114 may be communicated by any means known to a person skilled in the art, for example wireless communications such as NFC, WIFI, Bluetooth, the public Internet or any other form of viable means of data communications. In some embodiments, the payee payment threshold amount 114 maybe listed on a website hosted by a third party server, the third party server could be a server supporting an electronic platform for advertising goods and/or services. In yet another embodiment, the payee payment threshold amount 114 may be listed on a website of the payee/merchant. In specific implementations, the payee device 110 may be fitted with a wireless communications interface such as a Near Field Communication (NFC) interface to enable the payee device 110 to electronically communicate with the payer device 102 to advertise a list of goods with each having a corresponding payee payment threshold amount 114. NFC is a set of standards to establish radio communication between devices by bringing them into close proximity such as only a few centimetres. NFC standards cover communication protocols and data exchange formats, and are based on radio-frequency identification (RFID) technology. Alternatively, infra-red technology may also be used.

In an embodiment, in effecting a transaction by using various payment thresholds, a payer payment threshold amount 116 identifying a maximum amount that a payer is willing to pay for the transaction is generated at the payer device 102. This can, for example, be generated by the payer device 102 in response to an advertisement or a website by the payee/merchant advertising his/her goods. In another embodiment, the payer can also generate via the payer device 102 the payer payment threshold amount 116 setting the maximum amount that the payer is willing to pay for a specific quantity of good. In some embodiments, the specific good may not be advertised or listed by the merchant. In other words, the payer may set the payer payment threshold amount 116 that is not in response to any advertisement. In an embodiment, the payer payment threshold amount 116 is specific to a predetermined quantity of a certain type or identity of goods. In another embodiment, another payer payment threshold amount 116 may be set by the payer via the payer device 102 for another predetermined quantity of another type or identity of goods. In some embodiments, there may be at least one further payer payment threshold amount generated at the payer device, where the at least one further payer payment threshold amount identifies at least one further maximum amount that the payer is willing to pay for at least one further predetermined number of goods for the transaction. In an embodiment, the payer may have made arrangements/agreements with the payee, resulting in the payer payment threshold amount 116. In an embodiment, the payer payment threshold amount 116 generated by the payer device 102 may then be communicated to the payment network server 106 via the issuer server 104. In another embodiment, the payer payment threshold amount 116 may be communicated directly to the payment network server 106 without communicating the payee payment threshold amount 116 via the issuer server 104. In some embodiments, the payer payment threshold amount 116 may be communicated by any means known to a person skilled in the art, for example wireless communications such as NFC, WIFI, Bluetooth, the public Internet or any other form of viable means of data communications. In specific implementations, the payer device 102 may be fitted with a wireless communications interface such as a Near Field Communication (NFC) interface to enable the payer device 102 to electronically communicate with the payee device 110. In some embodiments, the payer payment threshold amount is not made known to the payee.

In specific implementations, the payment network server 106 is further configured to perform additional operations. For example, the payment network server 106 may be configured to determine if the payer payment threshold amount is equal to or more than the payee payment threshold amount. In an embodiment, the payment network server 106 may effect the transaction in response to determining that the payer payment threshold amount is equal to or more than the payee payment threshold amount. In an embodiment, the payment network server 106 may be configured to determine if the payer payment threshold amount is included in the associated payer account 118, either hosted in the payment network server 106 or in the issuer server 104. In some embodiments, the payment network server 106 may generate a transaction token 120 for the transaction when it is determined that the payer payment threshold amount is equal to or more than the payee threshold amount, the transaction token 120 including at least a transaction amount, and a transaction token validity time period during which the payer can proceed to initiate the transaction. In some embodiments, the payment network server 106 is also configured to send the transaction token 120 to the payer device 102. In some embodiments, the payment network server 106 is further configured to receive, from the payer device 102, a transaction request 122 during the transaction token validity time period to initiate the transaction. In some embodiments, the payment network server 106 is also configured to forward the transaction request 122 to the payee device when the transaction request 122 is received from the payer device. In some embodiments, the payment network server 106 is further configured to receive from the payee device 110, a transaction response 124 approving the transaction request. In some embodiments, the payment network server 106 is configured to initiate the transaction in response to receiving the transaction response 124.

In an embodiment, the transaction request 122 comprises corresponding transaction data relating to a transaction and identifies the payer and the payee, generally by way of identifiers each associated with the payer and the payee respectively. In some embodiments, the transaction data comprises the name of the payer, the name of the payee, the names of a payer bank and a payee bank associated with the issuer server and the acquirer server respectively, and a payee bank account number. In some embodiments, the transaction data also comprise the payer bank's code and the payee bank's code which identify a bank, for example Indian Financial System Code (IFSC), Bank Identifier Number (BIN), Society for Worldwide Interbank Financial Telecommunication (SWIFT) code, and International Bank Account Number (IBAN). In some embodiments, the transaction data also identify the goods and/or services to be purchased and a type or nature of the transaction. In some embodiments, the transaction data further identify a value or price of the goods and/or services (e.g., a transaction amount). In some embodiments, the transaction data also indicate a time and a date at which the transaction was initiated by the payer.

The following types of transaction data may be included in the transaction request 122:

Transaction level information:
Payer ID (anonymized)
Payee ID
Name of Payer
Name of Payee
Name of Payer Bank
Name of Payee Bank
Transaction Amount
Transaction Local Currency Amount
Date of Transaction
Time of Transaction
Type of Transaction
Date of Processing
Date to complete Transaction
Time to complete Transaction
Bank Codes (e.g. IFSC, BIN, SWIFT, IBAN etc)
Merchant Category Code (MCC)

Account (or Profile) Information:
Account ID (anonymized)
Payer Bank Account Number
Payee Bank Account Number

Payee/Merchant Information:
Payee/Merchant ID
Payee/Merchant Name
MCC/Industry Code
Industry Description
Payee/Merchant Country
Payee/Merchant Address
Payee/Merchant Postal Code
Payee/Merchant Acquirer Country
Payee/Merchant Acquirer ID

Issuer Information:
Issuer ID
Issuer Name
Issuer Country

In the preferred embodiment, the transaction request 122 is sent to the payment network 106 via the issuer server 104. This may be done via the Internet through an appropriate website associated with the issuer server 104. In another embodiment, the transaction request 122 may be sent directly to the payment network server 106, without having to communicate through the issuer server 104. This may be done via the Internet through an appropriate website associated directly with the payment network server 106. In yet another embodiment, the transaction request 122 is sent directly from the payer device 102 to the payee device 110. In an embodiment, for example, where the transaction is being performed at the website of the payee/merchant, the payer device 102 and the payee/merchant device 110 are in communication with a network, such as, the Internet (not shown for the sake of simplicity). In an embodiment, the transaction request 122 is sent from the payer device 102 to the payee device 110 via the network.

As mentioned above, the role of the payment network server 106 is to facilitate communication between the issuer server 104 and the acquirer server 108. Therefore, the payment network server 106 may serve as a means through which the acquirer server 108 may communicate with the issuer server 104 in a manner that payments and authentication may be performed. In specific implementations, the payment network server 106 may receive transaction data when initiating a transaction for a payer and subsequently store and/or update the transaction data in the database 112.

Additionally, the payment network server 106 may be configured to update the database 112 when initiating each transaction using a payment threshold. This helps to keep the transaction data relevant and updated. The payment network server 106 may also be configured to update the database 112 when a payer or a payee registers an account at the payment network server 106 or when a payer or a payee registers an account with a bank or a financial institution associated with an issuer server 104 or a bank or a financial institution associated with an acquirer server 108 respectively.

The processes to effect a transaction by having payment thresholds and subsequently initiating the transaction as described above involve multiple parties (e.g., payer/customer, payee/merchant, acquirer, issuer, payment facilitator). However, the transaction may essentially be viewed as a transaction between a payer and a payee (with the other parties facilitating the transaction).

FIG. 2 shows a flow chart 200 illustrating a computer-implemented method for effecting a transaction in accordance with the first embodiment.

Referring to FIG. 2, at step 202, a payee payment threshold amount 114 is received by the payment network server 106. In an embodiment, the payee payment threshold amount 114 is generated when the payee advertises his/her goods. In various embodiments, the payee payment threshold amount 114 identifies the minimum amount that the payee is willing to accept for a predetermined quantity of a good for that transaction. In some embodiments, there may be at least one further payee payment threshold amount generated at the payee device, where the at least one further payee payment threshold amount identifies at least one further minimum amount that the payee is willing to accept for at least one further predetermined quantity of a good for the transaction. In an embodiment, the payee payment threshold amount 114 together with the at least one further payee payment threshold amount generated by the payee may form a list of prices for each representing a predetermined quantity of goods. In an embodiment, the payee payment threshold amount 114 is generated by the payee via the payee device 110 to the payment network server 106. In an embodiment, the payee payment threshold amount 114 can be sent by the payee device 110 to the payment network server 106 via the acquirer server 108. In another embodiment, the payee payment threshold amount 114 can be sent by the payee device 110 to the payment network server 106 directly without communicating the payee payment threshold amount 114 via the acquirer server 108. In an embodiment, the payee payment threshold amount 114 comprises payee data identifying at least the payee account.

At step 204, a payer payment threshold amount 116 is received by the payment network server 106. In an embodiment, the payer payment threshold amount 116 is generated by the payer in response to an advertisement by a payee. Alternatively, the payer may, for example, generate the payer payment threshold amount 116 for a specific good in mind without being prompted by any advertisement. In embodiments, the payer payment threshold amount 116 may be received after the payee payment threshold amount 114 is received at the payment network server 106. In other embodiments, the payer payment threshold amount 116 may be received before or at the same time as the payee payment threshold amount 114 is received at the payment network server 106. In embodiments, the payer payment threshold amount 116 is generated in response to (e.g., identifies) the maximum amount that the payer is willing to pay for a predetermined number of goods for the transaction. In some embodiments, there may be at least one further payer payment threshold amount generated at the payer device, where the at least one further payer payment threshold amount is generated in response to at least one further maximum amount that the payer is willing to pay for at least one further predetermined number of goods for the transaction. In an embodiment, the payer payment threshold amount 116 is generated by the payer via the payer device 102 to the payment network server 106. In an embodiment, the payer payment threshold amount 116 can be sent by the payer device 102 to the payment network server 106 via the issuer server 104. In another embodiment, the payer payment threshold amount 116 can be sent by the payer device 102 to the payment network server 106 directly without communicating the payer payment threshold amount 116 via the issuer server 104. In an embodiment, the payer payment threshold amount 116 comprises payer data identifying at least the payer account. In various embodiments, the payer payment threshold amount 116 remains unknown to the payee. Additionally, the payer payment threshold amount 116 can be sent from the payer device 102 to the payee device 110 directly.

At step 206, the payment network server 106 is configured to determine if the payer payment threshold amount 116 is included in an amount in the associated payer account. In some embodiments, the payment network server 106 is configured to determine that the payer account associated with the payer is authorised to be used for the transaction based on the payer payment threshold amount 116. That is if the payer payment threshold amount 116 is included in the associated payer account, the associated payer account is determined to be authorised. In an embodiment, the associated payer account maybe one that is issued by a bank or financial institution and maintained at an issuer server 104. Alternatively, the payer may be a registered user of an account issued directly with the payment network server 106. In some embodiments, the payment network server 106 is configured to communicate a request to the issuer server 104 to check if the payer account associated with the issuer server 104 comprises at least the transaction amount towards the end of the time period. In such embodiments, the transaction amount may be comprised in the payer payment threshold amount 116. In some embodiments, the communication between the issuer server 104 and the payment network server 106 is through a secure protocol. In some embodiments, no other information is communicated between the issuer server 104 and the payment server 106 except for a binary answer of “yes” or “no” to the request to check if the payer account comprises at least the transaction amount. In an embodiment, the result of the request may be communicated to the payer device 102 if the transaction amount is not comprised in the payer account towards the end of the time period, before the end of the time period. In some embodiments, the result of the request is communicated directly to the payer device 102 by the payment network server 106. In an embodiment, the result of the request may be communicated to the payer device 102 by the payment network server 106 via the issuer server 104.

Based on the results of step 206, the payment network server 106 is configured to either send a failure message to the payer device 102 in step 212 once it is determined that the payer account associated with the payer is not authorised to be used for the transaction when it is determined that the payer payment threshold amount 116 is not included in the associated payer account, or to further determine if the payer payment threshold amount 116 is equal to or more than the payee payment threshold amount 114 at step 208.

At step 208, after the payment network server 106 has received the payee payment threshold amount 114 from the payee and the payer payment threshold amount 116 from the payer, and determined that the payer payment threshold amount 116 is included in the associated payer account, the payment network server is configured to determine if the payer payment threshold amount 116 is equal to or more than the payee payment threshold amount 114.

Based on the results of step 208, the payment network server 106 is configured to either send a failure message to the payer device 102 and the payee device 110 in step 214 if it is determined that the payer payment threshold amount 116 is less than the payee payment threshold amount 114, or to further effect the transaction at step 210.

In an embodiment, at step 210, the payment network server 106 is configured to further effect the transaction. In embodiments, the payment network server 106 effect the transaction if it is determined that the payer payment threshold amount 116 is equal or more than the payee payment threshold amount 114. In some embodiments, the payment network server 106 is further configured to send a message to the payer via the payer device 102 and/or the payee via the payee device 110 effecting the transaction. Alternatively, in other embodiments, the payment network server 106 is configured to send a failure message to the payer device 102 and the payee device 110 in step 216 if the transaction is not to be effected.

At step 218, in some embodiments, the payment network server 106 is configured to generate a transaction token 120 when it is determined that the payer payment threshold amount is equal to or more than the payee payment threshold amount. In an embodiment, the transaction token 120 may also be generated by the issuer server 104. In other embodiments, the transaction token 120 includes at least a transaction amount, and a transaction token validity time period during which the payer can proceed to initiate the transaction. In an embodiment, the transaction amount is equal to the payee payment threshold amount. In some embodiments, the transaction token 120 is unique for each transaction. In some embodiments, the transaction token 120 can be in the form of an identifier, or a PIN. In some embodiments, the transaction token validity time period during which the payer can proceed to initiate the transaction is determined and agreed upon by the payer and the payee at the onset when they send in the payer and payee payment threshold amount respectively. In some embodiments the transaction token validity time period is a predetermined time period set by a common platform in which the payer and the payee conducts the transaction. In some embodiments, the common platform can be a third party website or the payee website. In some embodiments, the transaction token validity time period start from the time at which the payer has received the transaction token 120 via the payer device 102.

Once the transaction token is generated at step 218, the transaction token 120 is sent to the payer device 102 at step 220. In a preferred embodiment, the payment network server 106 communicates the transaction token 120 directly to the payer device 102. In another embodiment, the payment network server 106 may communicate the transaction token 120 to the payer device 102 via the issuer server 104. In some embodiments, the transaction token 120 may be communicated by any means known to a person skilled in the art, for example wireless communications such as NFC, WIFI, Bluetooth, the public Internet (whether connected via a wireless or wired interface), or any other form of viable means of data communications. Alternatively, RFID and infra-red technology may also be used.

After step 220 is performed and the payer device 102 has received the transaction token 120, the payer via the payer device 102 has the opportunity to make a transaction request 122 to initiate the transaction. At step 222, a transaction request 122 is received from the payer device 102 at the payment network server 106. In some embodiments, the transaction request 122 has to be received during the transaction token validity time period to initiate the transaction. In some embodiments, the transaction request 122 includes payer data and other information as discussed in FIG. 1. In a preferred embodiment, the payer device 102 communicates the transaction request 122 directly to the payment network server 106. In another embodiment, the payer device 102 may communicate the transaction request 122 to the payment network server 106 via the issuer server 104. In some embodiments, the transaction request 122 may be communicated by any means known to a person skilled in the art, for example wireless communications such as NFC, WIFI, Bluetooth, the public Internet (whether connected via a wireless or wired interface), or any other form of viable means of data communications. Alternatively, RFID and infra-red technology may also be used.

At step 224, after the transaction request 122 is received from the payer device 102 at the payment network server 106, the payment network server 106 is configured to forward the transaction request 122 to the payee device 110. In a preferred embodiment, the payment network server 106 communicates the transaction request 122 directly to the payee device 110. In another embodiment, the payment network server 106 may communicate the transaction request 122 to the payee device 110 via the acquirer server 108. In some embodiments, the transaction request 122 may be communicated by any means known to a person skilled in the art, for example wireless communications such as NFC, WIFI, Bluetooth, the public Internet (whether connected via a wireless or wired interface), or any other form of viable means of data communications. Alternatively, RFID and infra-red technology may also be used.

At step 226, a transaction response 124 approving the transaction request 122 is received at the payment network server 106 from the payee device 110. In a preferred embodiment, the payee device 110 communicates the transaction response 124 directly to the payment network server 106. In another embodiment, the payee device 110 may communicate the transaction response 124 to payment network server 106 via the acquirer server 108. In some embodiments, no other information is communicated between the payee device 110 and the payment server 106 except for a binary answer of “yes” or “no” for the transaction response 124 to the transaction request 122. In an embodiment, the initiation of the transaction terminates if the payment server 106 receives a “no” for the transaction response 124 to the transaction request. The transaction is initiated at step 228 at the payment network server 106 when the payment network server 106 receives a transaction response 124 from the payee device 110 approving the transaction request 122. In some embodiments, the transaction amount is blocked in the payer account when the transaction is initiated at step 228. In embodiments, the initiation of the transaction at step 228 results in further standard transaction processes which are known to a person skilled in the art so as to complete the transaction.

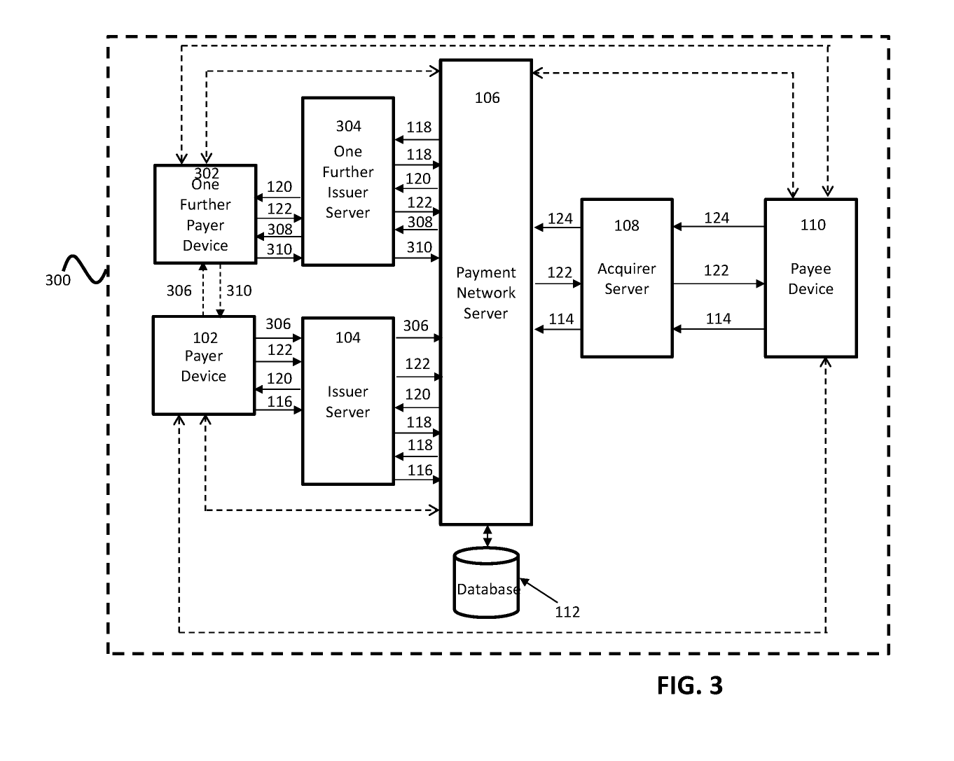

FIG. 3 depicts a block diagram of a system 300 for effecting a transaction in accordance with a second embodiment. In addition to the payer device 102, the issuer server 104, the payment network server 106, the acquirer server 108, the payee device 110 and the database 112 of the system 100, the system 300 depicted in FIG. 3 includes one further payer 302 and one further issuer server 304. The description for the components of the system 100, namely the payer device 102, the issuer server 104, the payment network server 106, the acquirer server 108, the payee device 110 and the database 112, and the data 114, 116, 118, 120, 122 and 124 have been discussed in the first embodiment in FIG. 1. In the following description, the focus will be on the additional components 302 and 304, and the data involving these components of the system 300. In embodiments, the one further payer device 302 and the one further issuer server 304 have the same capabilities and functions as the payer device 102 and the issuer server 104 as described previously for FIG. 1. In some embodiments, the one further payer device 302 may be in direct communication with a payment network server 106, without having to communicate with the one further payer issuer server 104. In specific embodiments, the one further payer device 302 may also be in direct communication with the payee device 110, without having to communicate with the one further issuer server 304 or the payment network server 106. In some embodiments, the payer device 102 may be in direct communication with the one further payer device 302. In specific embodiments, the one further issuer server 304 is the same as the issuer server 104. In other words, in specific embodiments, both the payer device 102 and the one further payer device 302 may share the same issuer server 104. In embodiments, although the system 300 presently depicts one further payer device 302 and one further issuer server 304, the system 300 can be expanded to comprise more than one further payer device and more than one further issuer server. In other words, the system 300 is not limited to include only the one further payer device 302 and the one further issuer server 304.

Referring to FIG. 3, in an embodiment, an invitation request 306 is received at the payment network server 106. In a preferred embodiment, the payer device 102 communicates the invitation request 306 directly to the payment network server 106. In another embodiment, the payer device 102 may communicate the invitation request 306 to the payment network server 106 via the issuer server 104. In some embodiments, the invitation request 306 is generated by the payer via the payer device 102 to invite at least one further payer to participate in the transaction. That is, the invitation request 306 may also be communicated from the payer device 102 to the one further payer device 302 directly to invite the one further payer to participate in the transaction. In some embodiments, the invitation request 306 can be communicated from the payer via the payer device 102 to both the one further payer device 302 and the payment network server 306. In some embodiments, the invitation request 306 can be sent via electronic mail, web messenger platforms such as WHATSAPP™, Short Message Service (SMS), Multimedia Message Service (MMS) etc.

In some embodiments, an invitation token 308 is generated at the payment network server 106 in response to receiving the invitation request 306. In some embodiments, the invitation token 308 comprises at least (i) a payee payment threshold amount 104 identifying the minimum amount that a payee is willing to accept for a predetermined quantity of goods for the transaction, and (ii) an invitation token validity time period during which the one further payer can procced to participate in the transaction. In a preferred embodiment, the invitation token 308 is sent to the one further payer device 302 directly from the payment network server 106. In another embodiment, the invitation token 308 is sent to the one further payer device 302 from the payment network server 106 via the one further issuer server 104.

In an embodiment, an invitation response 310 is received from the one further payer device 302 in response to the invitation request 306 at the payment network server 106. In an embodiment, the invitation response 310 may be communicated to the payment network server 106 from the one further payer device 302 directly. In some embodiments, the invitation response 310 can be communicated from the one further payer via the one further payer device 302 to the payment network server 106 via the one further issuer server 304. In some embodiments, the invitation response 310 may also be communicated to the payer via the payer device 102. This, for example, can be achieved either by receiving the invitation response 310 from the one further payer device 302 at the payer device 102 directly, or by receiving the invitation response 310 via the payment network server 106.

In an embodiment, there may be more than one iteration for steps 306-310 during a time period for the transaction. In some embodiments, the time period is a transaction validity time period during which the payee payment threshold amount 114 is valid. In an embodiment, the payee determined the transaction validity time period and is comprised in the payee payment threshold amount 114. In some embodiments, the payment threshold transaction token validity time period is a time period within the transaction validity time period. In some embodiments, the invitation token validity time period is a time period within the transaction validity time period.

Referring to FIG. 4, a flow chart of additional steps in the method for effecting a transaction in accordance with the second embodiment, wherein step 204 of FIG. 2A further comprises receiving an invitation request from the payer device, generating an invitation token, sending the invitation token and an invitation request to one further payer device, and receiving the payer payment threshold amount and a further payer payment threshold amount, is depicted. The purpose of FIG. 4 is to illustrate another embodiment of the method for effecting a transaction, where steps 204A, 204B, 204C and 204D of FIG. 4 are comprised into the method presented in FIG. 2 to allow the payer via the payer device 102 to invite at least one further payer via at least one further payer device 302 to participate in the transaction within the transaction validity time period. This advantageously allows the payer to invite the at least one further payer to participate in the transaction so as to enjoy a greater discount for the transaction or to meet the minimum predetermined quantity of goods set by the payee as required in the transaction before the end of the transaction validity time period. In embodiments, the method as depicted by FIGS. 2 and 4 can be extended to invite more than one further payer to participate in the transaction.

At step 204A, an invitation request 306 is received from the payer via the payer device 102 at the payment network server 106. The invitation request 306 is generated at the payer device 102 to invite at least one further payer to participate in the transaction. In some embodiments, the at least one further payer is a registered user at a platform for transactions with payment threshold. In some embodiments, the platform maybe a website or a mobile application hosted by a third party server, the third party server could be a server supporting an electronic platform for advertising goods and/or services. In another embodiment, the platform may be a website of the payee/merchant. In other embodiments, the invitation request 306 may comprise an invitation to invite the one further payer to register at the platform if the one further payer is not a registered user. In some embodiments, the invitation request 306 comprises at least a payee payment threshold amount for the transaction for a predetermined quantity of goods and the transaction validity time period. In some embodiments, the one further payer is chosen from a list of registered users at the platform associated with the payer. In some embodiments, the list of registered users at the platform associated with the payer is based on participation or transaction history by these registered users in proceeding to participate in previous transactions using a payment threshold. In an embodiment, information associated with the list of registered users is stored at the database 112. In other embodiments, the information associated with the list of registered users is stored at the third party server hosting the platform. In some embodiments, the participation or transaction history of the payer and the associated one further payer is stored at the database 112 related to the payment network server 106. In other embodiments, the participation or transaction history of the payer and the associated at least one further payer is stored at the third party server. In embodiments, more than one invitation request 306 can be received at the payment network server 106 at any one time.

At step 204B, an invitation token 308 is generated at the payment network server 106 in response to the invitation request 306 received at step 204A. In some embodiments, the invitation token 308 comprises at least a payee payment threshold amount 104 identifying the minimum amount that a payee is willing to accept for a predetermined quantity of goods for the transaction, and an invitation token validity time period during which the at least one further payer can procced to participate in the transaction. In some embodiments, the invitation token validity time period during which the payer can proceed to initiate the transaction is determined by the payer when the payer send out the invitation request to the at least one further payer. In some embodiments the invitation token validity time period is a predetermined time period set by the platform for transactions with payment threshold. In some embodiments, the platform for transactions with payment threshold can be a third party website, a mobile application or a payee website. In some embodiments, the invitation token validity time period start from the time at which the at least one further payer has received the invitation token 308 via the at least one further payer device 302.

At step 204C, the invitation request 306, together with the invitation token 308 generated at step 204B, are forwarded by the payment network server 106 to the one further payer via the one further payer device 302. In some embodiments, the payment network server 106 may send a notification to the payer via the payer device 102 informing the payer that the invitation request together with the invitation token 308 has been sent to the one further payer via the one further payer device 302. In embodiments, the invitation request 306, together with invitation tokens 308, can be sent to a plurality of further payer devices 302 at the same time or one after the other to invite more than one further payer to participate in the transaction. In some embodiments, the invitation request 306, together with the invitation token 308 generated at step 204B, are forwarded by the payment network server 106 via a third party server through a mobile application to the one further payer via the one further payer device 302.

At step 204D, an invitation response 310 is received at the payment network server 106 in response to the invitation request. In some embodiments, the invitation response 310 comprises at least one further payer payment threshold amount identifying the maximum amount the at least one further payer is willing to accept a predetermined quantity of a good for the transaction. In some embodiments, the invitation response 310 also comprises authorizing the payer to represent the at least one further payer to send a consolidate transaction request 122 to the payee on behalf of the at least one further payer. In some embodiments, if no invitation response 310 from the at least one further payer device 302 is received at the payment network server 106 at the end of the validity time period during which the invitation request 308 is to be responded, the predetermined invitation response 310 may be considered as a “no”. In an embodiment, a failure notification to receive at the payment network server 106 an invitation response 310 from the one further device 302 may be sent to the payer device 102. In some embodiments, the failure notification sent to the payer device 102 may comprise options to send another invitation request to another further payer device. In some embodiments, the failure notification may be sent by the payment network server 106 directly to the payer device 102. In an embodiment, the failure notification may be communicated to the payer device 102 by the payment network server 106 via the issuer server 102. In some embodiments, the payer payment threshold amount 116 may be received by the payment network server 106 prior to receiving the invitation response 310 comprising the at least one further payer payment threshold amount. In some embodiments, the payment network server 106 is configured to proceed to step 206 after receiving the payer payment threshold amount 116 and the at least one further payer payment threshold amount. At the end of step 204D, the method for effecting a transaction continue with the steps 206-228 which can be found in the description for FIG. 2.

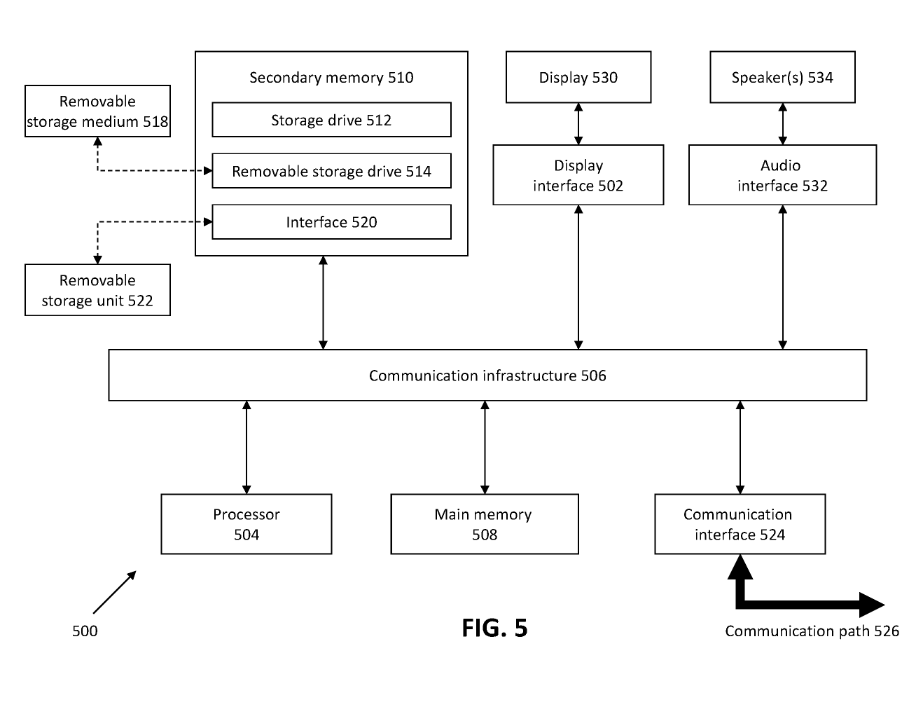

FIG. 5 depicts an exemplary computer/computing device 500, hereinafter interchangeably referred to as a computer system 500, where one or more such computing devices 500 may be used to facilitate execution of the above-described method for effecting a transaction. In addition, one or more components of the computer system 500 may be used to realize a computer. The following description of the computing device 500 is provided by way of example only and is not intended to be limiting.

As shown in FIG. 5, the example computing device 500 includes a processor 504 for executing software routines. Although a single processor is shown for the sake of clarity, the computing device 500 may also include a multi-processor system. The processor 504 is connected to a communication infrastructure 506 for communication with other components of the computing device 500. The communication infrastructure 506 may include, for example, a communications bus, cross-bar, or network.

The computing device 500 further includes a main memory 508, such as a random access memory (RAM), and a secondary memory 510. The secondary memory 510 may include, for example, a storage drive 512, which may be a hard disk drive, a solid state drive or a hybrid drive and/or a removable storage drive 514, which may include a magnetic tape drive, an optical disk drive, a solid state storage drive (such as a USB flash drive, a flash memory device, a solid state drive or a memory card), or the like. The removable storage drive 514 reads from and/or writes to a removable storage medium 518 in a well-known manner. The removable storage medium 518 may include magnetic tape, optical disk, non-volatile memory storage medium, or the like, which is read by and written to by removable storage drive 514. As will be appreciated by persons skilled in the relevant art(s), the removable storage medium 518 includes a computer readable storage medium having stored therein computer executable program code instructions and/or data.

In an alternative implementation, the secondary memory 510 may additionally or alternatively include other similar means for allowing computer programs or other instructions to be loaded into the computing device 500. Such means can include, for example, a removable storage unit 522 and an interface 520. Examples of a removable storage unit 522 and interface 520 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 522 and interfaces 520 which allow software and data to be transferred from the removable storage unit 522 to the computer system 500.

The computing device 500 also includes at least one communication interface 524. The communication interface 524 allows software and data to be transferred between computing device 500 and external devices via a communication path 526. In various embodiments of the inventions, the communication interface 524 permits data to be transferred between the computing device 500 and a data communication network, such as a public data or private data communication network. The communication interface 524 may be used to exchange data between different computing devices 500 which such computing devices 500 form part of an interconnected computer network. Examples of a communication interface 524 can include a modem, a network interface (such as an Ethernet card), a communication port (such as a serial, parallel, printer, GPIB, IEEE 1394, RJ25, USB), an antenna with associated circuitry and the like. The communication interface 524 may be wired or may be wireless. Software and data transferred via the communication interface 524 are in the form of signals which can be electronic, electromagnetic, optical or other signals capable of being received by communication interface 524. These signals are provided to the communication interface via the communication path 526.

As shown in FIG. 5, the computing device 500 further includes a display interface 502 which performs operations for rendering images to an associated display 530 and an audio interface 532 for performing operations for playing audio content via associated speaker(s) 534.

As used herein, the term “computer program product” may refer, in part, to removable storage medium 518, removable storage unit 522, a hard disk installed in storage drive 512, or a carrier wave carrying software over communication path 526 (wireless link or cable) to communication interface 524. Computer readable storage media refers to any non-transitory, non-volatile tangible storage medium that provides recorded instructions and/or data to the computing device 500 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 500. Examples of transitory or non-tangible computer readable transmission media that may also participate in the provision of software, application programs, instructions and/or data to the computing device 500 include radio or infra-red transmission channels as well as a network connection to another computer or networked device, and the Internet or Intranets including e-mail transmissions and information recorded on Websites and the like.

The computer programs (also called computer program code) are stored in main memory 508 and/or secondary memory 510. Computer programs can also be received via the communication interface 524. Such computer programs, when executed, enable the computing device 500 to perform one or more features of embodiments discussed herein. In various embodiments, the computer programs, when executed, enable the processor 504 to perform features of the above-described embodiments. Accordingly, such computer programs represent controllers of the computer system 500.

Software may be stored in a computer program product and loaded into the computing device 500 using the removable storage drive 514, the storage drive 512, or the interface 520. Alternatively, the computer program product may be downloaded to the computer system 500 over the communications path 526. The software, when executed by the processor 504, causes the computing device 500 to perform functions of embodiments described herein.

It is to be understood that the embodiment of FIG. 5 is presented merely by way of example. Therefore, in some embodiments one or more features of the computing device 500 may be omitted. Also, in some embodiments, one or more features of the computing device 500 may be combined together. Additionally, in some embodiments, one or more features of the computing device 500 may be split into one or more component parts.

In an implementation, the payment network server 106 may be generally described as a physical device comprising at least one processor 602 and at least one memory 604 including computer program code. The at least one memory 604 and the computer program code are configured to, with the at least one processor 602, cause the physical device to perform the operations described in FIG. 2 and FIG. 4. An example of the payment network server 106 is shown in FIG. 6.

For example, the method of FIG. 2 and FIG. 4 may be implemented as software and stored in a non-transitory fashion in the secondary memory 510 or the removable storage drive 514 of the computer device 500.

It will be appreciated by a person skilled in the art that numerous variations and/or modifications may be made to the present invention as shown in the specific embodiments without departing from the spirit or scope of the invention as broadly described. For example, the above description mainly discusses the use of a Bluetooth connection, but it will be appreciated that another type of secure wireless connection, such as Wi-Fi, can be used in alternate embodiments to implement the method. Some modifications, e.g. adding an access point, changing the log-in routine, etc. may be considered and incorporated. The present embodiments are, therefore, to be considered in all respects to be illustrative and not restrictive.

What is claimed:

1. A computer-implemented method, at a server, for effecting a transaction, the method comprising:
receiving, from a payee device, a payee payment threshold amount identifying a minimum amount that a payee is willing to accept for a predetermined number of goods for the transaction;
receiving, from a payer device, a payer payment threshold amount identifying a maximum amount that a payer is willing to pay for the transaction;
determining if the payer payment threshold amount is equal to or more than the payee payment threshold amount; and
effecting the transaction if it is determined that the payer payment threshold amount is equal to or more than the payee payment threshold amount.

2. The method according to claim 1, further comprising:
determining if a payer account associated with the payer is authorised to be used for the transaction based on the payer payment threshold amount, wherein it is determined that the payer account is authorised to be used for the transaction if an amount in the payer account exceeds the payer payment threshold amount

3. The method according to claim 1, further comprising:
generating a transaction token for the transaction when it is determined that the payer payment threshold amount is equal to or more than the payee payment threshold amount, the transaction token including at least a transaction amount, and a transaction token validity time period during which the payer can proceed to initiate the transaction; and
sending the transaction token to the payer device.

4. The method according to claim 3, further comprising:
receiving, from the payer device, a transaction request during the transaction token validity time period to initiate the transaction, the transaction request including payer data; and
forwarding the transaction request to the payee device.

5. The method according to claim 4, further comprising:
receiving from the payee device, a transaction response approving the transaction request; and
initiating the transaction in response to receiving the transaction response.

6. The method according to claim 1, further comprising:
receiving, from at least one further payer device, at least one further payer payment threshold amount identifying at least one further maximum amount that at least one further payer is willing to pay for the transaction;
determining if the at least one further payer payment threshold amount is equal to or more than the payee payment threshold amount,
wherein the transaction is effected if it is determined that the at least one further payer payment threshold amount is equal to or more than the payee payment threshold amount.

7. The method according to claim 6, further comprising:
receiving, from the payee device, at least one further payee payment threshold amount identifying at least one further minimum amount that the payee is willing to accept for at least one further predetermined number of goods for the transaction;
determining if at least one of (i) the payer payment threshold amount and (ii) the at least one further payer payment threshold amount is equal to or more than at least one of (i) the payee payment threshold amount and (ii) the at least one further payee payment threshold amount;
wherein the transaction is effected if it is determined that at least one of (i) the payer payment threshold amount and (ii) the at least one further payer payment threshold amount is equal to or more than at least one of (i) the payee payment threshold amount and (ii) the at least one further payee payment.

8. The method according to claim 6, further comprising:
receiving, from the payer device, an invitation request inviting the at least one further payer device to participate in the transaction;
sending the invitation request to the at least one further payer device;
wherein the at least one further payer payment threshold amount is received from the at least one further payer device in response to the invitation request to participate in the transaction.

9. The method according to claim 8, further comprising:
generating an invitation token in response to receiving the invitation request, the invitation token including at least an invitation token validity time period during which the at least one further payer can proceed to participate in the transaction; and
sending the invitation token to the at least one further payer device.

10. The method according to claim 9, wherein the invitation token further comprises the payee payment threshold amount.

11. The method according to claim 3, wherein the transaction amount is equal to the payee payment threshold amount.

12. The method according to claim 11, wherein the transaction amount is blocked in the payer account when the transaction is initiated.

13. The method according claim 3, wherein the step of generating a transaction token for the transaction when it is determined that the payer payment threshold amount is equal to or more than the payee payment threshold amount further comprises generating the transaction token by a further server, the further server being operationally connected to the server.

14. An apparatus for effecting a transaction, the apparatus comprising:
at least one processor; and
at least one memory including computer program code;
the at least one memory and the computer program code configured to, with at least one processor, cause the apparatus at least to:
receive, from a payee device, a payee payment threshold amount identifying a minimum amount that a payee is willing to accept for a predetermined number of goods for the transaction;
receive, from a payer device, a payer payment threshold amount identifying a maximum amount that a payer is willing to pay for the transaction;
determine if the payer payment threshold amount is equal to or more than the payee payment threshold amount; and
effect the transaction if it is determined that the payer payment threshold amount is equal to or more than the payee payment threshold amount.

15. The apparatus according to claim 14, wherein the at least one memory and the computer program code is further configured with the at least one processor to:
determine if a payer account associated with the payer is authorised to be used for the transaction based on the payer payment threshold amount, wherein it is determined that the payer account is authorised to be used for the transaction if an amount in the payer account exceeds the payer payment threshold amount.

16. The apparatus according to claim 14, wherein the at least one memory and the computer program code is further configured with the at least one processor to:
generate a transaction token for the transaction when it is determined that the transaction will proceed, the transaction token including at least a transaction amount, and a transaction token validity time period during which the payer can proceed to initiate the transaction; and
send the transaction token to the payer device.

17. The apparatus according to claim 16, wherein the at least one memory and the computer program code is further configured with the at least one processor to:
receive, from the payer device, a transaction request during the transaction token validity time period to initiate the transaction, the transaction request including payer data; and
forward the transaction request to the payee device.

18. The apparatus according to claim 17, wherein the at least one memory and the computer program code is further configured with the at least one processor to:
receive from the payee device, a transaction response approving the transaction request; and
initiate the transaction in response to receiving the transaction response.

19. The apparatus according to claim 14, wherein the at least one memory and the computer program code is further configured with the at least one processor to:
receive, from at least one further payer device, at least one further payer payment threshold amount identifying at least one further maximum amount that at least one further payer is willing to pay for the transaction;
determine if the at least one further payer payment threshold amount is equal to or more than the payee payment threshold amount,
wherein the transaction is effected if it is determined that the at least one further payer payment threshold amount is equal to or more than the payee payment threshold amount.

20. The apparatus according to claim 19, wherein the at least one memory and the computer program code is further configured with the at least one processor to:
receive, from the payee device, at least one further payee payment threshold amount identifying at least one further minimum amount that the payee is willing to accept for at least one further predetermined number of goods for the transaction;
determine if at least one of (i) the payer payment threshold amount and (ii) the at least one further payer payment threshold amount is equal to or more than at least one of (i) the payee payment threshold amount and (ii) the at least one further payee payment threshold amount;
wherein the transaction is effected if it is determined that at least one of (i) the payer payment threshold amount and (ii) the at least one further payer payment threshold amount is equal to or more than at least one of (i) the payee payment threshold amount and (ii) the at least one further payee payment.

21. The apparatus according to claim 19, wherein the at least one memory and the computer program code is further configured with the at least one processor to:
receive, from the payer device, an invitation request inviting the at least one further payer device to participate in the transaction;
send the invitation request to the at least one further payer device;
wherein the at least one further payer payment threshold amount is received from the at least one further payer device in response to the invitation request to participate in the transaction.

22. The apparatus according to claim 21, wherein the at least one memory and the computer program code is further configured with the at least one processor to:
generate an invitation token in response to receiving the invitation request, the invitation token including at least an invitation token validity time period during which the at least one further payer can proceed to participate in the transaction; and
send the invitation token to the at least one further payer device.

23. The apparatus according to claim 22, wherein the invitation token further comprises the payee payment threshold amount.

24. The apparatus according to claim 16, wherein the transaction amount is equal to the payee payment threshold amount.

25. The apparatus according to claim 24, wherein the transaction amount is blocked in the payer account when the transaction is initiated.

26. The apparatus according to claim 16, wherein the at least one memory and the computer program code is further configured with the at least one processor to generate a transaction token for the transaction when the transaction is effected is further configured to generate the transaction token by a further server, the further server is operationally connected to the server.

27. A non-transitory computer-readable medium storing program code, the program code executable by a processor of a computing system to cause the computing system to:
receive, from a payee device, a payee payment threshold amount identifying a minimum amount that a payee is willing to accept for a predetermined number of goods for the transaction;
receive, from a payer device, a payer payment threshold amount identifying a maximum amount that a payer is willing to pay for the transaction;
determine if the payer payment threshold amount is equal to or more than the payee payment threshold amount; and
effect the transaction if it is determined that the payer payment threshold amount is equal to or more than the payee payment threshold amount.
